(19) United States
(12) Patent Application Publication
(10) Pub. No.: US 2010/0205021 A1
(43) Pub. Date: Aug. 12, 2010

(54) SYSTEM AND METHOD FOR COGNITIVE DECISION SUPPORT IN A CONDITION BASED FLEET SUPPORT SYSTEM

(76) Inventors: Stephen P. Jewett, O'Fallon, MO (US); Andrew Wall, O'Fallon, MO (US); Thomas Edward Shepherd, Chesterfield, MO (US)

Correspondence Address: Hayes Soloway P.C., 3450 E. Sunrise Drive, Suite 140, Tucson, AZ, 85718, US

(21) Appl. No.: 12/368,904

(22) Filed: Feb. 10, 2009

(51) Int. Cl. G06Q 10/00

(52) U.S. Cl. 705/7

(57) ABSTRACT

A cognitive decision support fleet management and maintenance decision system may comprise a first cognitive decision support system to process information regarding a plurality of platforms and generate a list of condition based response activities and a weighted ranking of the probability of success of each condition based activity. A second cognitive decision support system may be tasked by the first to, and configured to, provide a plurality of ranked courses of action. A third cognitive decision support system may be tasked by the second to, and be configured to, assess resource availability for each condition based response activity. The second cognitive decision support system may be further configured to generate from the list of condition based response activities and the resource availability assessment for each condition based response, a plurality of recommended courses of action for the platform. The courses of action may be weighted according to an order of preference in carrying out each.

### FIELD

The disclosed subject matter relates, generally to systems for cognitive decision support of condition based logistics and maintenance decisions such as are involved, e.g., in fleet management. The disclosure has particular utility in connection with management of fleet-wide operations, including mission and maintenance activities of a fleet of vehicles such as aircraft, and will be described in connection with such utilities, although other utilities are contemplated.

### BACKGROUND

Various cognitive decision making systems provide decision making assistance, for example in condition based maintenance systems, are known in the art. For example condition based systems such as condition based operations or maintenance systems facilitate decision making such as if and when to perform certain condition based responsive activity, including logistics and maintenance activity in response to a known and/or anticipated condition existing in a fleet platform.

Condition-based operations and maintenance (CBO&M) is known and is aimed at the detection and diagnosis of particular conditions of equipment operation. By sensing and identifying the existence of a particular condition, such as, in the maintenance context, a course of action may be performed to reduce the impact of the condition upon operations. This could include identifying the need for the performance of a particular maintenance operation(s) upon the occurrence of the condition, or imminent occurrence of such a condition, requiring a responsive maintenance action. Condition based maintenance (“CBM”) is discussed in Chandler “Overhaul & Maintenance”, Aviation Week.com (Jan. 3, 2007) and Jarrell et al., Prognostics and Condition Based Maintenance (CBM) A Scientific Crystal Ball, http://www.pnl.gov/dsom/publications/36771.pdf. (including a prognosticative data analysis system for predicting maintenance needs of a particular system/sub-system), as well as at https://acc.dau.mil/CommunityBrowser.aspx?id=128766 Prognostics and Health Management (“PHM”), the disclosures of which are hereby incorporated by reference.

In typical cognitive decision support systems for maintenance of fleet platforms maintenance activity is identified for a particular platform and human intervention then takes over to identify, organize, plan and execute the particular maintenance activity for a given platform or set of platforms. There is, in addition, no existing system for carrying out fleet-wide logistics/maintenance activities utilizing cognitive decision support technology.

Accordingly, there is a need in the art for a cognitive decision support system for condition based responses on a fleet-wide basis such as condition based maintenance activity responses to needed maintenance conditions in a fleet platform.

### SUMMARY

Systems and methods are disclosed relating to cognitive decision support for fleet management and maintenance decision making.

In one embodiment, a fleet management system is disclosed and includes a first cognitive decision support system configured to process information regarding a plurality of platforms comprising a fleet capable of an overall fleet mission. The first cognitive decision support system is further configured to generate a list of condition based response activities for one or more platforms of the plurality of platforms, and a weighted ranking of the probability of success of each such condition based response activity. The fleet management system also includes a second cognitive decision support system capable of being tasked by the first cognitive decision support system to, and configured to, provide a plurality of ranked courses of action for the one or more platforms. The fleet management system also includes a third cognitive decision support system capable of being tasked by the second cognitive decision support system to, and configured to, assess the resource availability for each condition based response activity. The second cognitive decision support system is further configured to generate from the list of condition based response activities and the resource availability assessment for each condition based response, a plurality of recommended courses of action for the one or more platforms.

In another embodiment, a fleet mission performance management system is disclosed. The system includes a fleet agent capable of receiving status information regarding platforms within a fleet of platforms, fleet data information defining the platforms comprising the fleet, and a mission capability of each platform for a particular platform mission and the platform equipment requirements for such mission capability. The fleet agent is configured to generate a list of condition based response activities for each platform and a probability of success of each such condition based response activity. The system further includes a course of action agent configured to receive the list of the condition based response activities from the fleet agent and to utilize the list of condition based response activities to generate a resource availability request for each such condition based response activity. The system still further includes a resource agent configured to receive the resource availability request and access information regarding the performance steps needed to perform each such condition based response activity, and the availability of any resource needed to perform each such performance step. The resource agent is further configured to generate a resource availability status report to the course of action agent. The course of action agent is further configured to use the resource availability status report for each condition based response activity and provide a weighted list of courses of action.

In another embodiment, a fleet maintenance management system is disclosed that includes a fleet agent capable of receiving status information regarding platforms within a fleet of platforms, fleet data information defining the platforms comprising the fleet, the status information comprising a list of condition based maintenance response activities, and for each activity in the list of condition based maintenance response activities, a weighting of the likelihood that each activity will resolve a fault condition in a fleet platform. The system also includes a course of action agent configured to receive the list of the condition based maintenance response activities from the fleet agent and utilize the list of condition based maintenance response activities to generate a resource availability request for each such condition based maintenance response activity. The system further includes a resource agent configured to receive the resource availability request and access information regarding the performance steps needed to perform each such condition based maintenance response activity, and the availability of any resource needed to perform each such performance step. The resource agent is further configured to generate a condition based maintenance response resource availability status report to the course of action agent. The course of action agent is further configured to use the resource availability status report for each condition based maintenance response activity and provide a weighted list of courses of action.

In yet another embodiment, a method of managing fleet mission performance is disclosed. The method includes receiving status information regarding platforms within a fleet of platforms and fleet data information defining mission capability of particular platforms for a particular platform mission in a fleet agent, and generating in the fleet agent an output comprising a list of the status of platform mission capability for each platform for at least one mission. The method also includes receiving the list of the status of platform mission capability from the fleet agent in a course of action agent and utilizing the course of action agent to generate a list of condition based response activities and to generate a resource availability request for each such condition based response activity. The method further includes receiving the resource availability request in a resource agent and accessing through the resource agent, information regarding the performance steps needed to perform each such condition based response activity and the availability of any resource needed to perform each such performance step, and generating in the resource agent, a resource availability status report to the course of action agent. The method further includes using the resource availability status report for each condition based response activity in the course of action agent along with an operational requirements rules engine and associated knowledge base to generate a set of courses of action.

### BRIEF DESCRIPTION OF THE DRAWINGS

The features, functions, and advantages that have been discussed can be achieved independently in various embodiments of the present disclosure or may be combined in yet other embodiments further details of which can be seen with reference to the following description and drawings, wherein like numerals depict like parts, and wherein:

FIG. 1 shows schematically and in block diagram form, a cognitive decision support for a condition based fleet mission operation or maintenance support system according to an embodiment of the disclosed subject matter;

FIG. 2 shows schematically and in block diagram form, an integrated vehicle health maintenance (“IVHM”) system as may be used according to an embodiment of the disclosed subject matter;

FIG. 3 shows schematically and in block diagram form further details of a system according to FIG. 1;

FIG. 4 shows in schematic and block diagram form further details of an embodiment of a course of action (“CoA”) agent;

FIG. 5 shows in schematic and block diagram form an embodiment of a maintenance system;

FIG. 6 shows in schematic and block diagram form further details of the cooperation of portions of the system of FIG. 1;

FIG. 7 shows a flow chart of a process according to an embodiment of the disclosed subject matter; and,

FIG. 8 shows a flow chart of a process according to an embodiment of the disclosed subject matter.

### DETAILED DESCRIPTION

The disclosed subject matter relates generally to fleet operational management, including logistics and maintenance. A fleet, for purposes of this disclosure relates to a plurality of platforms. The platform may be a vehicle, e.g., an airplane, ground vehicle or water bound vehicle. Each platform may have a set of definable missions and a set of systems and subsystems, and each mission may have a list of systems which need to be operational or have a subset of sub-systems within each particular system that need to be fully operational or operational to some defined set of capabilities for the performance of a particular platform mission. This may be referred to as a platform operational status or mission capability and may include, e.g., fully mission capable (“FMC”), which may mean herein capable of performing any mission for which the platform was designed and/or is capable, partially mission capable (“PMC”), which may mean capable of performing some but not all of a list of missions for which the platform was designed and/or is capable of performing or some or all of the list of missions included in a FMC status, but at a reduced capability for one or more of such missions, and non-mission capable (“NMC”), meaning not capable of performing any mission at any level of performance, i.e., out of commission and in need of immediate maintenance or replacement. The overall capabilities of all of the platforms in the fleet during a given period of time can be defined for purposes of the present application as a fleet operational status or fleet mission capability.

There may be information such as platform equipment information and platform mission information relating to the operational readiness of the respective platforms. For example, a platform equipment list may vary by combat mission. An aircraft capable of multiple missions, a bombing raid, close combat support, carrier air patrol, may require different systems/subsystems, different armament, etc. Different platform equipment may be required for taking off or landing on an aircraft carrier rather than an air field. Different platform equipment may be required for a non-combat mission such as ferrying a replacement pilot to an aircraft carrier or ferrying the platform itself to a location for maintenance and repair services to be performed. An airplane may need different configurations to carry human passengers and cargo or different configurations to carry small boxes and parcels as opposed to large crates, pallets and the like. Different platform equipment may be required for ferrying personnel and/or cargo in a combat zone than out of the combat zone.

Activity(ies) needed for appropriate utilization of a fleet platform to perform a platform mission in support of the fleet-wide mission, according to various embodiments of the disclosed subject matter may include, in the maintenance context, when, where and how to perform a condition based response maintenance activity responsive to a known and/or anticipated platform system condition requiring maintenance. By integrating the selection and performance of the most effective and efficient condition based response maintenance activities over the entire set of fleet platforms, the disclosed subject matter may be utilized as a fleet-wide operational management system, e.g., a fleet-wide maintenance management system in support of the fleet performing a fleet-wide mission(s).

According to various embodiments of the disclosed subject matter, a suite/collection of cognitive decision support systems can assist in making informed decisions about fleet operations/maintenance (such as by evaluating the availability and capability of platforms comprising the fleet, including platform mission readiness status). A system/subsystem contained in a fleet platform, and thus the platform in which the system/sub-system resides, may be evaluated, including for example, to make operational decisions regarding the utilization of the platform for the overall fleet mission(s). The evaluation may include maintenance and logistics actions for a system/subsystem based on such diagnostics/prognostics information regarding the platform system/subsystem. The management system disclosed may then utilize collaborative cognitive decision making systems to evaluate and make decisions concerning fleet-wide activities, such as maintenance. The availability of resources and operational demand relating to the utilization of platforms throughout the fleet may be optimized. In particular, specific condition based maintenance response actions and the status of platforms and respective systems/subsystems or components may be evaluated. Optimized and streamlined fleet management decisions, such as regarding maintenance at the fleet level, can address such things as operational disruptions, particularly unanticipated ones, mission capacity, the need for huge parts inventories, etc.

It will be understood that, while a maintenance decision making system is one embodiment, the system may be used for operational fleet-wide decision making. As an example the current “health” (mission capability) status of platforms in the fleet, could be other than maintenance related, or could be maintenance related as well as related to other operational information. An analog to the list of faults and possible corrections could be a list of the geographical location, mission capability, crew identification, current status (fueled, armed and how armed, crew on board, in the air, etc,) and a list of possible activities in which the platform can participate as well as fleet mission and sub-mission requirements. It will also be understood that these analogs can apply to other than aircraft and other than military missions.

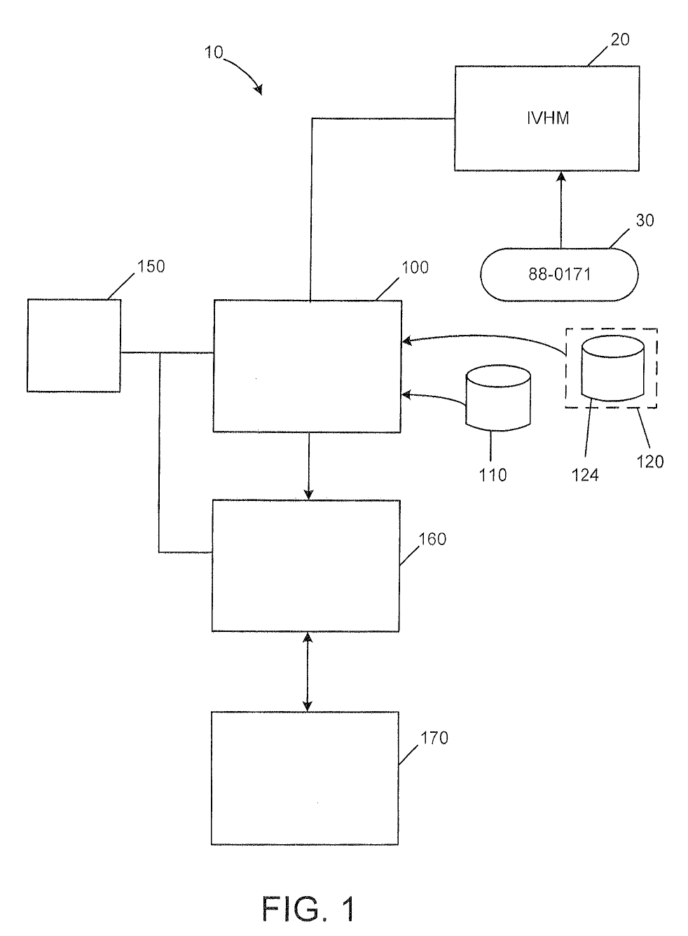

Referring now to the drawings, and in particular FIG. 1, according to one embodiment of the disclosed subject matter, a fleet-wide management system 10 may employ cognitive decision makers/decision support systems (“cognitive agents”) such as a course of action (“CoA”) agent 160 in conjunction with a fleet agent 100 and maintenance agent 170. The fleet agent 100, CoA agent 160, and maintenance agent 170 may apply decision models and rules (operational rules, business rules, specific activity rules), herein collectively “rules”, about what data to find and how to apply that data to the job at hand. The system 10 may apply reasoning over a problem space and the cognitive rules to make cognitive rule based decisions, as is known in the art. In the presently preferred embodiment, the rules may be applied. According to an embodiment of the disclosed subject matter the CoA agent 160, as part of a suite (“collection”) of cognitive agents, as discussed further below, for example, may be used for fleet-wide operational/management decision making support. An individual cognitive agent may solicit another agent(s) for obtaining and/or processing or otherwise using/analyzing information and making/suggesting decisions, in the evolution of a decision regarding an operational/management issue and integrating such decisions into a fleet-wide management system. The querying/queried agent may break up the problem into tasks based on the problem/inquiry for which a decision is required and may obtain and/or process or otherwise analyze information and rules not available to the querying/queried agent in support of responding to specific inquiries. The responses such as inquiries formed to guide the response from the queried agent, and the focused responses may support the overall fleet operational/maintenance management system operation. The queried agent may in turn inquire of an additional agent(s) for similar decision making support. How the agents are organized and how they interact and what specific tasks they direct or perform and/or information they process and rules they apply may be specific to the task to be accomplished, and for a given system 10, may vary from fleet mission to fleet mission and over time as, e.g., the fleet changes in nature or mission.

Each such cognitive decision support system (“agent”) may identify and pull together disparate data from a data storage location or locations unique to the agent and, modify, organize interpret and/or collate it to make sense to the inquiring agent or human/automatic user of the fleet operation/maintenance management system. The cognitive decision support system/agent may process/analyze the data according to its own set of cognitive rules and knowledge base(s) for performance of a particular task(s).

According to various embodiments, cognitive agents may be employed in a fleet management environment to make operational decisions required for the fleet to perform a fleet mission (s). In the specific fleet maintenance environment, the presently preferred embodiment, the maintenance of the platforms in the fleet in support of enabling the performance of the mission(s) of the overall fleet may be supported with a suite/collection of cooperating cognitive decision making support systems. This may involve identifying and resolving issues of interactive reliability of separate platforms and/or platform equipment within a platform, as relates to platform readiness for one or more of a list of missions for which the platform may be used, within the overall fleet operational/maintenance management system. The collaboration of different agents with different focuses facilitates achieving the greater good, the overall operational performance of the fleet, and specifically within the maintenance context, the overall mission readiness of the fleet through efficient, timely and effective required maintenance.

As an example in operation within a fleet maintenance environment, the collection of cognitive decision support systems may be utilized in determining the probability of timely maintaining (repair, replacement, substitution) a platform with least impact on overall fleet operation, and perhaps other aspects, such as cost, reduction of lost opportunity and other management related or financial related issues.

FIG. 1 illustrates schematically and in block diagram form an illustrative condition based fleet mission operation or maintenance support system 10 employing a suite/collection of cognitive support systems such as a fleet agent 100, a course of action (“CoA”) agent 160 and an operational agent such as a maintenance agent 170. An integrated vehicle (platform) health maintenance system (“IVHM”) 20 tracks and stores vehicle (platform) readiness condition information such as equipment status, “health”, information from respective elements (vehicles/platforms) of a fleet, as explained in more detail below. The health maintenance information may include platform system/subsystem and component (hereafter “platform equipment”) status/condition, such as parameter values, platform equipment faults, platform equipment fault histories, etc. The IVHM system 20 may also evaluate a fault or a prospective fault in a system/subsystem on a platform 30 and provide a listing of a set of likely sub-system/components constituting the root cause for the fault. As used from here on in the present disclosure, unless otherwise specifically stated, a fault shall include both actual faults in systems/subsystems and anticipated faults based on prognosticative system/sub-system analysis. Furthermore, a fault may broadly include a condition resulting in the system/subsystem being partially operative, non-operative, or wholly operative. For example, a fault may exist in a system/subsystem preventing use of some functionality but allowing use of other functionality. A fault may be a complete failure of a system/subsystem, or a fault may simply be a condition requiring an action, for example a status check, without affecting the operation of the system/subsystem. Similarly a fault may be understood in a broader fleet management context as a subset of conditions requiring a condition based response action/activity, such as the receipt of a bill of lading requiring the shipment of a package from point A to point B prior to some specific time, the detection of an incoming hostile aircraft that must be met with a response from a “fleet” however the fleet of platforms may be defined.

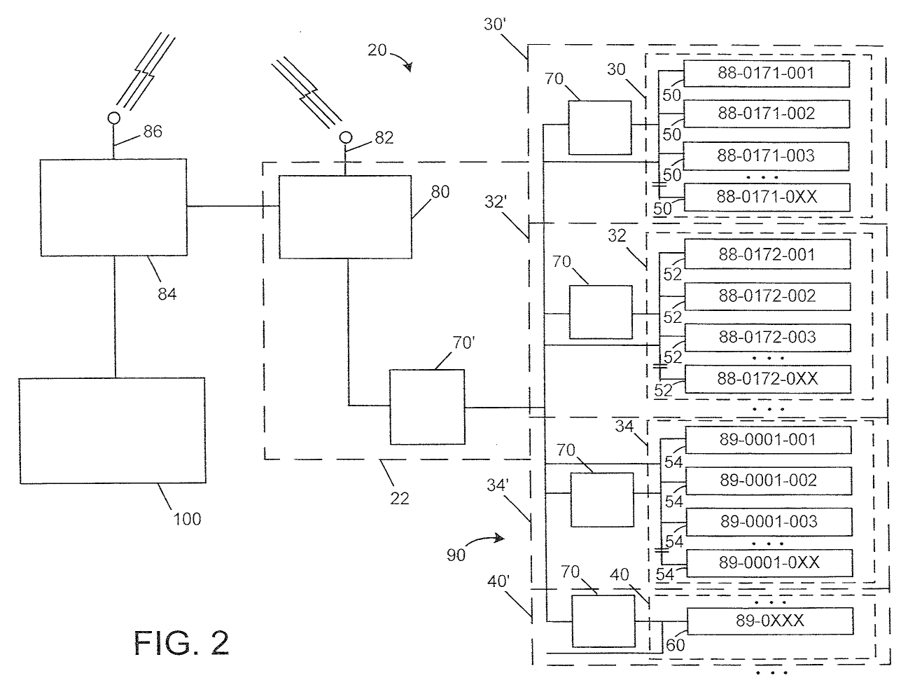

The platform equipment parameters, such as hours in service, hours in service at a given revolutions per minute (“RPM”), at a given temperature, at a given pressure and the like, vibration, vibration history, etc., along with indications of actual faults (system or subsystem faults) that have already occurred, can be collected from monitors and data processors as explained in more detail below in regard to FIG. 2. Such platform equipment condition (“health”) information can be indicative of an operational readiness level, for fleet operational management, or a fault in need of a condition based maintenance response activity. For example, an integrated vehicle health management (IVHM) system may include smart sensors, diagnostic and prognostic software for sensors and components, and model based reasoning systems for subsystem and system fault evaluation.

As illustrated in FIG. 2 in schematic and block diagram form, an exemplary IVHM system 20 may include a platform data monitoring system 90 for gathering platform equipment data for exemplary from platforms 30, 32, 34, 40. The monitoring systems 30′, 32′, 34′, 40′ relating to platforms 30, 32, 34, 40 may be imbedded in a platform 30, 32, 34, 40 or form part of a platform-side system 30′, 32′, 34′ 40′. By way of example each platform 30, 32, 34, 40 may comprise an aircraft making up a fleet of carrier based aircraft, a carrier air group. For example, the platforms 30, 32 may be the same type of aircraft, as illustrated designated type “88”, with a first designated by its illustrative individual platform designation number (such as a tail number), “0171,” and second by its individual platform designation number “0172.” A third illustrative fleet platform 34 may be a second type of aircraft designated a type “89” with an individual platform designation as an example being “0001”. A fourth member of the fleet 40 may be of the same type, e.g., type “89” with an individual platform designation number 0XXX” but which may be located remotely from other platforms 30, 32, 34 in the fleet, e.g., below the flight deck on the hanger deck or in the air currently performing a mission or even on shore operating in conjunction with other platforms in the fleet from a shore-based airfield.

Each of the platforms may have a set of systems/subsystems 50a-d, 52a-d, 54a-d, 60a-d such as illustratively designated 88-0171-001-88-0171-0XX, 88-0172-001-88-0172-0XX, 89-0001-001-89-0001-0XX, and 89-0XXX-001-89-0XXX-0XX, respectively for the platforms 30, 32, 34 and 40, hereafter referred to as “platform equipment” 50a-d, 52a-d, 54a-d, 60a-d. It will be understood that the fleet may comprise many more types of platforms and each may have different lists of systems/subsystems comprising the platform equipment 50a-d, 52a-d, 54a-d and 60a-d being monitored by the IVHM system 20. The lists of systems/subsystems may also include individual components of a system being monitored and the lists of systems/sub-systems may be platform mission specific or the requirements/capabilities of sub-systems/components within a system may be mission specific, as will be explained in more detail below. The status/capabilities, or projected longevity or the like of systems/subsystems in a given platform and also fleet-wide may be individual platform specific or overall fleet mission specific and thus, may vary over time or for other operational or maintenance related reasons. To the extent dedicated to a single platform the platform monitoring portion of the IVHM system 20 could be referred to as a platform agent 30′, 32′, 34′ 40′.

The platforms 30 may be connected to a respective data processor 70 which may be imbedded in the platform 30, 32, 34, 40 or, as illustrated, may be part of a platform-side IVHM data system 30′, 32′, 34′, 40′. The processors 70 may perform or direct some part or all of the monitoring of the respective platform equipment and communicate the results directly or indirectly to the fleet agent 100, or simply form part or all of a communication link to the fleet agent 100. The IVHM system 20 may also include, as illustrated in FIG. 2 a remote processor 70′, which may partly or wholly replace all of the platform-side processors 70, i.e., as when the processors 70 are imbedded in the platform 30, 32, 34, 40 itself, and each platform 30, 32, 34, 40 may communicate directly with the remote processor 70′. The remote processor 70′ also may supplement the functioning of the imbedded/platform-side processors 70.

The platform equipment monitoring portion of the IVHM 20 may simply collect data from the platform 30, 32, 34, 40 regarding the respective platform equipment 50a-d, 52a-d, 54a-d and 60a-d and collate and/or format the data for transmission to the fleet agent 100, e.g., through a transmitter 80 with antenna 82 to a further remote location where the fleet agent 100 and its associated data base(s) and processor(s) are located, having a receiver 84 with antenna 86. It will be understood that many different forms of communication such as wired, wireless, satellite, internet and the like may be utilized between the monitors on the platform equipment 50a-d, 52a-d, 54a-d and 60a-d depending on the makeup of the fleet and the location of individual platforms, and the illustrative arrangement in FIG. 2 is only an example. By way of example for a carrier air group, the processors 70 (imbedded in the individual aircraft or plane-side) may be hard wire connected to a remote location 22 for connection to the fleet agent 100 with some additional processing by the remote processor 70′. The fleet agent 100 may be in another part of the same ship to which the fleet of platforms is attached and, except for a remote platform 40 located other than on the ship at any given time, communications may all be hard wired through an existing on-board communications network. In the case of a fleet of overnight deliver cargo aircraft the IVHM processors 70 (imbedded in the aircraft comprising an individual fleet platform or in the platform equipment or both) may communicate by satellite or wireless telephone or internet link communication to a fleet agent 100 when in use or through a system more similar to that shown in FIG. 2 when some or all of the platforms are on the ground and at a single geographic and, thus, not in operation.

It will be understood as well that many forms of logic may be employed from logic embedded within “smart” platform equipment monitors located in the actual piece of platform equipment, to logic embedded in the platform processors, to platform-side monitor processors and, as illustrated in FIG. 2 a remote processer intermediate the platform equipment and the fleet agent 100. Ultimately, however, the IVHM system 20 provides the fleet agent with information (for example a list) of data relating to the status/condition of platform equipment for platforms in the fleet, along with perhaps some other information such as geographic (shipboard) location, current operational use status, pilot/crew availability and the like.

According to one embodiment, the IVHM 20 may detect and evaluate platform system faults and provide to the fleet agent 100 a listing of each such platform system/sub-system fault that affects the platform's fitness for service, e.g., PMC or NMC, for some or all platform mission(s), and also a listing of the probable root causes of the condition. These may be ranked. These root causes may be determined better locally than at the fleet agent 100, though the function may be shifted partly or entirely to the fleet agent 100 with the IVHM 20 serving partly or only as a platform equipment condition information gathering system. The local assessment of root causes, e.g., within the IVHM system 20, may be more convenient, however, due to, e.g., the collection and storage locally of platform equipment operational and maintenance history and current diagnostic and prognostic data or even due to the availability of human input from maintenance technicians familiar with peculiarities of the particular piece of platform equipment.

Returning now to FIG. 1, the fleet agent 100 may be connected to a database such as a GO-81 Clone 110, which may be a subset of the US government's logistics and maintenance database. A database system such as this is used by the Air Force as part of an integrated maintenance data system for collection, storage, and dissemination of data for maintenance of weapons systems and equipment. The GO-81 is a USAF GO database created for security purposes with only the data needed (unclassified) for maintenance management.

The database 110 used according to an embodiment of the disclosed subject matter may be a subset of the GO database that is sufficient to provide the fleet data to the fleet agent 100. Such fleet data may define the platform content of the fleet and the necessary and appropriate platform equipment for each mission associated with a platform, and like operational fleet platform information. The GO-81 Clone database 110 and associated logic may be used to access historical and legacy data from the GO-81 clone and other data bases in support of defining logistics infrastructure size, quantity, and mission orientation. The database 110 may be utilized by the fleet agent to gather, correlate, and process fleet platform data, including historical data for each platform as well as the entire fleet and to interactively diagnose the health of a platform. Some or all of the information received from the IVHM system 20 may be stored in the database 110. As noted, the diagnosis, at least to the extent of developing a ranked list of suspected root causes may be done entirely within the IVHM system. To this extent also, the fleet agent 100 and IVHM 20 for purposes of the present disclosure and appended claims may be considered as one cognitive decision making system whose job is to identify condition based response activities that are needed, root causes of action in the case of platform equipment faults in a maintenance context, or other fleet management conditions, as noted above, which require a condition based response action in a broader fleet management context. This system (IVHM 20 and fleet agent 100) may then perform collectively or separately another function, to task another cognitive decision making support system(s) to provide courses of action to deal with the respective condition based response needed.

The fleet agent 100 through the DSS system 120 may initialize the web-interface with the fleet agent 100 defining the fleet known platforms, location and last known health before any reports come in from the IVHM system 20. The IVHM system 20 reports may occur periodically, such as hourly, daily, etc., or when the operational readiness status of a platform is changed due to a fault, or the fleet or mission(s) significantly change, or the like. Incoming fleet data reports from the IVHM system 20 can then be continued to be analyzed to indicate the overall health of the fleet. The fleet agent 100 may be responsible for identifying problems relating to a particular platform(s). The CoA agent 160 may then optimize the fleet operations, schedules, etc. along with the needs for and schedule for required condition based response activity, such as condition based response maintenance activity depending on the need, schedules, missions and the like, as well as resource availability.

The DSS 120 and associated database 124 may be a repository for the entire set of fleet data needed, e.g., for fleet maintenance, e.g., the current health of all platforms, consumables, parts, personnel, facilities and the like needed for each condition responsive maintenance activity, fleet-wide, and issued work orders for the steps in accomplishing each required condition based maintenance response activity and the current schedule and state of completion of each.

The IVHM 20 may also designate the probability that a particular sub-system has incurred a fault or may incur a fault, based, e.g., on historical data regarding prior similar system faults or existing and/or historical metrology data and the like. It will be understood that the IVHM 20 and fleet agent 100 may be considered together as a fleet monitoring system and the monitoring tasks and fleet makeup and requirements analysis can be apportioned between the two as desired and appropriate. According to a preferred embodiment, the IVHM 20 provides a list of platform equipment systems in each platform that are determined not operable for service and an associated list of the sub-system(s) of the system that are likely to be causing the system to be not operable for service, which is weighted as to likelihood of being the actual root cause.

For example the platform may have an engine fault, which may be defined in a variety of ways for the system involved, its platform, etc., such as being totally inoperable to being partially operable with certain limitations. A jet engine may have its afterburners system inoperable and thus be out-of-commission (“OOC”) so far as combat operations are concerned, but operable for other purposes.

For purposes of this application a sub-system may have a number of component parts cooperating with each other or may be a single part, and this definition of sub-system may be determined at least in part by the logistics and maintenance inventorying system in use and its definitions of spare parts needed/available for maintenance of a platform system. It will be understood that in a prognosticative system the “OOC” fault may be a projected fault and the rankings may then include a probability that each of a list of sub-systems may be what will cause the anticipated fault and perhaps also some probability of the event occurring within some range(s) of time (e.g., engine service hours, etc.).

As an example, an engine fault may have a number of possible root causes, such as, compressor fault, fuel injection fault, bearing fault, etc. The IVHM system 20 provides the fleet agent 100 with a list of these subsystems and the likelihood that each is the root cause or will be a root cause. IVHM system 20 may also provide the probabilities of the subsystem becoming a root cause within some length(s) of time (e.g., hours of operation).

The fleet agent 100 may then update the status of a web-site 150 web-page from the initialized version to list, e.g., the platforms and the operational condition of their platform equipment, through or in conjunction with the DSS 120 and its database 124.

The fleet agent 100 may then task the course of action agent 160 to generate a list of courses of action. The CoA agent may receive a list of condition based response activity and generate a maintenance resource availability request for each activity. For example, the CoA agent 160 may task the maintenance agent 170 to generate a list of required resources and their availability. Upon receipt of the resource availability report the CoA agent 100 produces a list of ranked courses of action.

According to embodiments of the disclosed subject matter, cognitive decision support systems (“DSSs”) may be employed. Such systems can interactively support decision-making activities to, e.g., help decision makers compile useful information from raw data, documents, personal knowledge, and/or business rules/models to identify and solve problems and make decisions. Decision support systems may include in the present context interactive computer systems, such as model/business rule and knowledge base DSS systems. Data warehousing and on-line analytical processing (“OLAP”) and Web-based analytical applications may be used. As discussed, models of cognition and decision behaviors may be utilized. Integrated and coordinated collaborative DSS systems may be employed for the purposes of fleet-wide operational decision making, such as the utilization of elements of a weapons system (a fleet of weapons platforms), to perform designated platform missions, and perhaps multiple such missions, supporting the overall operational mission of the entire fleet. More specifically, the operational mission may be identifying, planning and carrying out the most cost effective and timely performance of maintenance for the fleet in support of the fleet being capable of performing its operational mission(s).

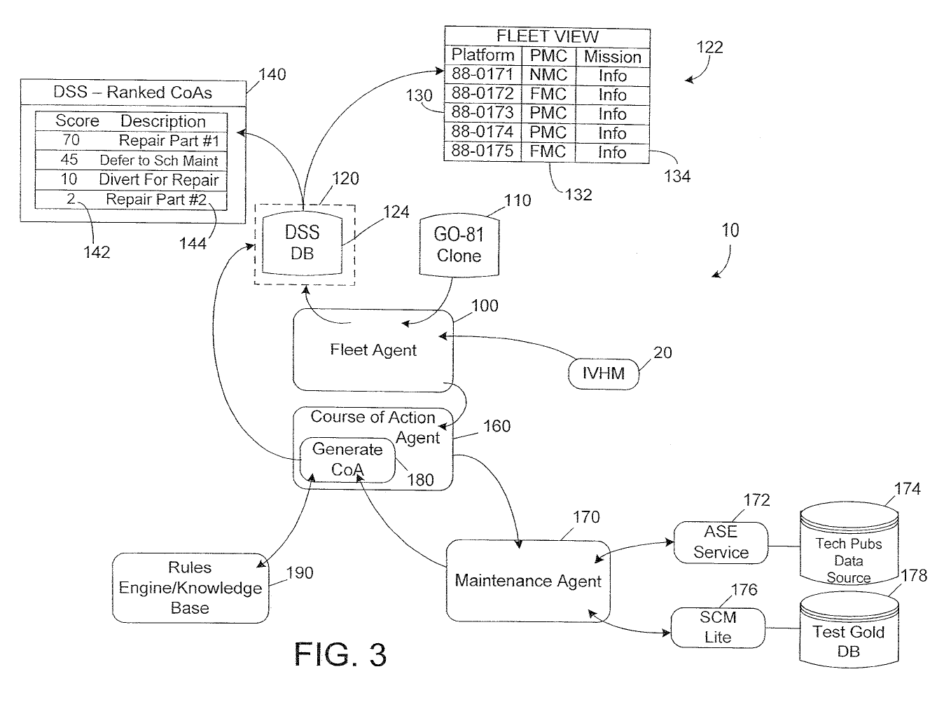

As may be seen from the schematic block diagram of FIG. 3 the fleet agent 100 may retrieve fleet data from the GO database system 110 and in cooperation with a cognitive decision support system 120, including its own database 124, may generate and distribute the fleet data, e.g. in the form of a mission readiness status (FMC, PMC or NMC for specific missions. This may be part of an initializing of the management system 10. The DSS 120 database 124 functions as a local store to keep data needed for cognitive decision support. The readiness status may then be made available to users, e.g., on a web-page 122 of a website. The web-site web-page 122 may display the platforms, as illustrated by way of example designated 88-0171-0175 in a platforms column 130, the readiness status in a readiness status column 132 and the designator of the mission for which the readiness status applies, in the mission information column 134, which may include, as illustrated by way of example a brief summary of the mission.

The fleet agent 100 may also utilize this fleet data, and perhaps other data and knowledge as well, to task the CoA agent 160 to generate a list of proposes CoAs. The fleet agent 100, according to a preferred embodiment, may utilize information received from the IVHM 20 regarding platform equipment faults for the platforms in the fleet and ranked listed possible root causes comprising conditions requiring some form of maintenance response. The DSS 120 and its database 124 may utilize this and other information regarding the fleet to populate the web-page 122 with updates to the platform readiness condition or the like. The CoAs generated by the CoA agent 160 may be listed in a weighted or ranked order, and may in conjunction with the DSS 120 be listed on a web-page 140 with the associated weighting factor, which may indicate the ranked probabilities of a successful completion of the particular course of action, the ranked desirability of performing the particular course of action, the best order in which to perform a list of CoAs, etc.

The CoA agent 160 may comprise a dynamic resource manager, or in conjunction with the DSS 120, may be comprised as a portion of the DSS 120 which may, in part by managing the web-page interface(s) of the system and the various web-applications discussed herein, keep track of the fleet overall status, individual platform status, necessary maintenance and schedules and completion status of each, etc. It will be understood that these interfaces may be to a human maintenance manager(s) or to an automated maintenance management decision maker (not shown). In the latter case, specific displays on web-pages may not be needed, other than perhaps for status monitoring by non-decision makers. The overall fleet status and scheduling of events effecting fleet utilization and operations, e.g., condition based maintenance response actions can then be to utilized to optimize the status and conduct of the maintenance activities, and indirectly thereby the management of the fleet, or to directly manage fleet activities in accomplishing a particular mission(s).

In generating the list(s) of CoAs the CoA agent 160 may utilize yet another cognitive decision support system, the maintenance agent(s) 170. The maintenance agent 170 may in turn make inquiries to other databases and/or cognitive decision support systems, such as is illustratively shown in FIG. 3. An advanced search engine (“ASE”) service 172 which may comprise a software system may be utilized to search such information as technical publications for the respective piece of platform equipment to determine such things as the parts and other equipment, such as metrology and test equipment needed, and the steps necessary, to perform a given condition based responsive maintenance activity with regard to a platform. Another database 178 referred to Test Gold, a consumables, parts and materials database, may be searched by a cognitive decision support system 176 such as supply chain management decision support system (e.g., “SCM lite”). SCM lite 176 may be a subset of a larger supply chain management database and decision support system, such as a maintenance parts and materials interface as has been created and used by Boeing. SCM lite 176 may be tailored specifically to the particular fleet in question. The inquiry into the database 178 may be as to the availability of facilities, parts, metrology and test equipment and personnel to perform the condition responsive maintenance activity in question. These activities may be in response to the CoA agent 160 acting upon the tasking of the fleet agent 100 to assess, through the maintenance agent 170, the steps required, resources and resource availability for the condition responsive maintenance activities for each particular system/subsystem on each platform 30 that is not operable for service in some fashion, e.g., to change the readiness status of the platform 30 to another level for one or more missions for which the platform 30 is designed and used, by eliminating a fault.

It will be understood that according to an embodiment of the disclosed subject matter the job of the fleet agent 100 may be to task the CoA agent 160 to figure out the solution for the best way to carry out fleet maintenance, given the listings of fleet platform equipment that has failed and the suspected root causes and their probability of being the actual root cause, along with the input from the maintenance agent 170. The information received from the fleet agent 100 can be considered a report from the IVHM system 20, as to the fleet situation, which may also be provided in some form to the web-page 122. The CoA agent 160 may also utilize what can be considered as a report from the maintenance agent 170 as to the maintenance resource/availability situation. The maintenance agent 170 gives the CoA agent 160 the choices, in the exemplary maintenance management system 10 as to the what, where, when and how of each necessary condition responsive maintenance activity for each piece of platform equipment in the fleet. The CoA agent 160 can then optimize between the choices using rules and a knowledge base(s). The rules and knowledge base(s) may involve requirements and information that is not strictly limited to maintenance issues, even in the exemplary maintenance management system 10. The rules may include the necessity of the platform for a fleet mission, whether substitutes are available, the likelihood a substitute can be as effective as the platform, the timing, priority and importance of the mission for which the platform is being considered, etc. Other more maintenance-activity related information to which rules may be applied may include such information as the likelihood the fault will occur (in a prognosticative system), the severity of the fault to the platform capabilities (in conjunction with the related issue of importance of the capability to the platform mission), etc. The rules may determine where the maintenance can/will be done and when,

A condition based maintenance response activity with a low chance of correcting a root cause to make the platform equipment operable for service may get the highest weighting as a CoA simply because it can be done immediately with parts on hand. The weighting may also be based on time to accomplish the activity, whereas other choices may take much more time, involve ferrying parts to the platform site or the platform to a maintenance site, etc.

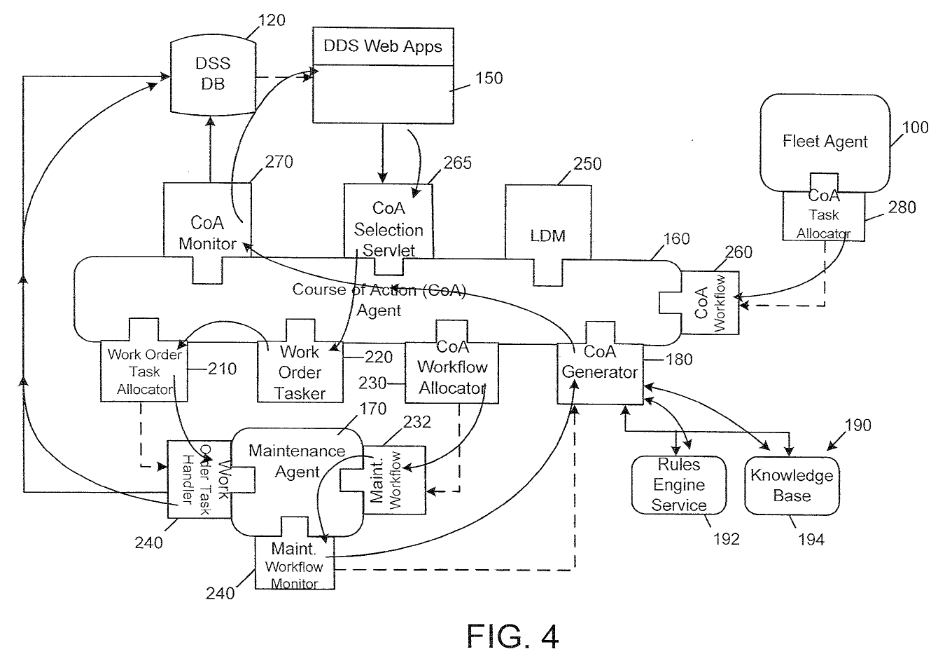

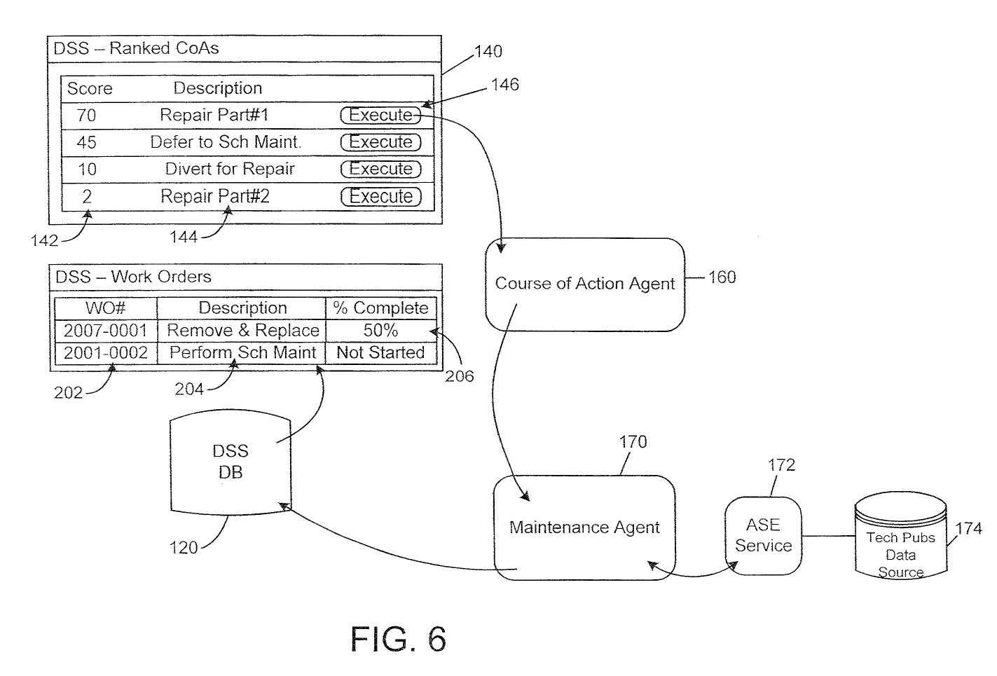

Turning now to FIG. 4, there is shown in schematic and block diagram form, further detail of the course of action (“CoA”) agent 160. The CoA agent 160 may receive from the fleet agent 100 an allocation of a set of activities, including courses of action of condition based responses, a list of platform equipment for a given platform that is not operable for service, and the suspected root cause(s). The courses of action may be listed on a web-page 140 by the DSS 120 as shown by way of example in FIG. 6. These may include such as repair/replace part 1 (e.g., a system A component), defer repair of system A to the next regularly scheduled maintenance, divert platform for replacement of system A, repair/replace part 2, etc. Referring back to FIG. 4, the list of such condition based responses may be forwarded to the CoA agent 160 by the fleet agent 100 through a CoA task allocator 280. The list of condition based responses may be received by the CoA agent 160 through a CoA workflow controller 260.

The CoA workflow controller 260 may direct a CoA workflow allocator 230 to communicate with a maintenance workflow assessor 232 in the maintenance agent 170 to have the maintenance agent 170 assess and evaluate the maintenance agent, as noted above, assess and evaluate the steps required, availability of resources, parts, labor, facilities, test equipment and the like through cooperation with the (“ASE”) service 172 and the supply chain management cognitive decision support system 176, as noted above. The maintenance agent 170 may then provide the CoA agent 160, through a maintenance agent 170 maintenance workflow monitor 240 condition based response information. This condition based response information may be a resource evaluation report. In the exemplary case of the fleet maintenance management system, the resource evaluation report may include the weighted probabilities of success in correcting the condition affecting a platform equipment's operability for service, and an assessment and evaluation of the resource requirements and availability for each such condition based response. It will be understood that there are various ways in which the maintenance agent 170 and the CoA agent 160 may split these functions, so long as the CoA agent 160 ultimately is able to evaluate both the list of contemplated condition based responses, and the resource availability for each. Thus, the maintenance agent 170 may be provided with the weighting for each contemplated condition based response having been generated by the IVHM system 20 or the IVHM system 20 in combination with the fleet agent 100, or the fleet agent 100 in combination with the CoA agent 160. In such a case the CoA agent 160 may simply receive information concerning resources needed and their availability in the resource report. Alternatively in one embodiment, the maintenance agent 170 may also evaluate the resources needed and their availability in light of the selection weightings, such as the probability of success in correction of the problem with the piece of fleet platform equipment that is affecting the platform's operability for service.

Still referring to FIG. 4, the CoA agent 160 may then generate in a CoA generator 180 a list of courses of action which may also be weighted by such as probability of success, such as based on being the most likely to have the greatest effect, least likely to result in loss of time, personnel, opportunity for other utilization, etc. and, in a preferred embodiment of a maintenance management system, having the greatest probability of effectiveness in timely changing the status of the fleet platform to fully mission capable, which also may be individual mission specific. In other words, by way of example, the highest weighted condition responsive action, in the exemplary maintenance management system may be to replace part 1. While this action may have the lowest probability of being the root cause of the fleet platform piece of equipment whose operability for service is in question, the part may be the most readily available, due to on board inventory stock or rapid delivery capability or the like, and thus the quickest and most efficient way to try to favorably resolve an out of service status of the fleet platform. Parts, personnel, facilities or the like may be unavailable in a more timely manner, so the system may give a course of action that is less likely to solve the root cause a higher weight than another more likely root cause fix. In effect the CoA agent 160 may weigh more heavily a possible stop-gap measure on the chance that performing the designated condition responsive maintenance action on the fleet platform piece of equipment, while awaiting the availability of other possibly more likely solutions (other root cause corrections), may work, and thus ultimately avoid the need for the other measures that are not currently readily available or performable. This could also be influenced by other factors, such as the part is due to be replaced in an upcoming regularly scheduled maintenance in any event. The choices for maintenance may include ignoring the fault until the next regularly scheduled maintenance or ignoring the possibility of the fault occurring before the next regularly scheduled maintenance, or performing other possible activities that may resolve the fault while awaiting a scheduled maintenance or the availability of parts, facilities or personnel for an unscheduled maintenance session, on the probability that the action taken will resolve the fault condition.

The CoA agent 160 may then provide the ranked list of CoAs to the DSS system 120 and its associated database 124 through a CoA monitor 270 for listing on a web-page 140 (as shown in FIG. 3 and FIG. 6) on the web-site. The web-page 140 listing of the ranked CoAs may be utilized by a human decision maker, or the information displayed on the web-page regarding the ranked CoAs may be utilized by a further automated decision making system. The further automated decision making system may be separate from the DSS system 120 or may be a part of the DSS system 120. This automated decision maker may select the CoA to be implemented. The automated decision maker may utilize its own set of rules and a rules service engine along with a knowledge base, similarly to the functioning of the CoA generator 180.

The CoA agent 160 may be informed, of a decision maker, e.g., a human decision maker, interfacing with the web-page 140 and selecting a CoA, through a CoA selection servlet 265 and may then begin the process of generating work orders for carrying out the specific selected CoA, through a work order tasker 220. The work order tasker 220 may direct a work order task allocator 210 to allocate work order tasks, essentially the subject matter of a respective selected CoA, by a work order task handler 212. The work order task handler 212 may communicate to a web-page 200, such as illustrated in FIG. 6, on the web-site through the DSS system 120 and its associated database 124 to list on the web-page 200 the work orders that may be associated with the completion of all of the required steps to complete the condition based responsive maintenance activity. This may include in a simple maintenance activity entering an order for a part to ship's stores and producing a work order for a technician to install the part. In a more complex situation, a work order may also be issued to test the part after installation. A still further complicated situation may involve a work order to move the fleet platform aircraft from the flight deck below to the hanger deck in preparation for the part replacement. The required condition based responsive maintenance activity may require the generation of an order for a part from shore-based inventory and a work order to ferry the part to the ship at sea where the platform is located or a work order to ferry the platform to the location of the part, or a facility where the part can be more properly or efficiently installed and/or tested. These work order decisions may also involve the same kinds of cognitive decision support system functions where, e.g., the part may be replaced on ship or on shore and the decision whether to ferry the part to the ship or vice-versa involves availabilities of the necessary resources to do the ferrying and/or to do the maintenance as well as such considerations as the time to install and test on board the ship as opposed to on shore, and like considerations.

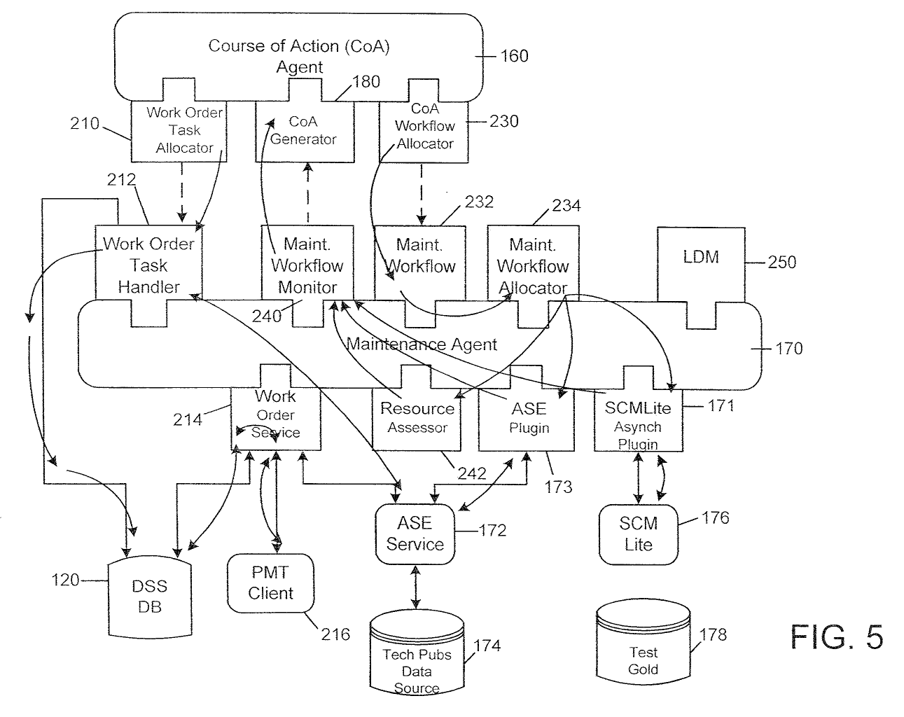

Turning now to FIG. 5 the activities of the maintenance agent 170 and its interaction with the CoA agent 160 of FIGS. 1 and 4 may be seen in further detail. As can be seen in FIG. 5, the maintenance workflow assessor 232 may work through a maintenance workflow allocator 234 to interface with the ASE service 172 and supply change management system 176 through an ASE plug-in interface 173 and an SCM asynchronous plug-in interface 171, respectively. The ASE service 172 may access one or more databases, such as ones containing the appropriate technical manuals and maintenance and logistics procedures to retrieve information needed to produce appropriate work orders to perform the CoA designated for execution. The maintenance agent 170 maintenance workflow allocator 234 may interface with the maintenance workflow monitor 240 through a resource assessor 242, a software resource within the maintenance agent 170 which may collate the information received from the ASE service 172 regarding the necessary parts, labor, facilities and materials, etc. indicated by the identity of a listed possible root cause (a designation code), provided to the maintenance agent 170 by the CoA agent 160, and the information received from the SCM 176 regarding the available parts, labor, facilities and materials, etc., and provide an input to the maintenance workflow monitor 240 for assessing the where, when, how and by whom, etc. of the correction of the root cause.

The work order task handler 212 may work through the DSS system 120 and its associated database 124 to interface with a work order service 214 which work order service 214 may communicate with a process monitoring tool (“PMT”) client 216, which may track the status of work orders generated by the system and allow the DSS system 120 to list the status of any given work order on a web-page 200 of the web-site. A logic data model (“LDM”) 250 may include a useful software pattern for initializing the data structure(s) of the system 10, and more specifically the CoA agent 160.

Turning now to FIG. 6 there is illustrated a decision support system web-site work orders web-page 200, which may display information regarding work orders and their completion status, such as a work order numbers list 202, a work order description list 204, and a work order completion status list 206. Also illustrated in FIG. 6 is the input possibly from a condition based maintenance system web-site course of action web-page 140. The web-page 140 may be used to interface with the CoA agent 160 to instruct the CoA agent 160 to execute one or more of a list of CoAs which, as noted may be a weighted list. Clicking on the “execute” designation in the execute column 146 may task the CoA agent to take the steps needed to plan, organize and carryout the selected CoA in conjunction with the maintenance agent 170.

Referring back to FIG. 5, the CoA agent 160 may then employ this information received from the maintenance agent 170 in a CoA generator 180 to generate a list of courses of action as noted above for each piece of fleet platform equipment in need of a condition based response. As noted above, the CoA agent 160, and more specifically the CoA generator 180 may perform this function in cooperation with the maintenance agent 170.

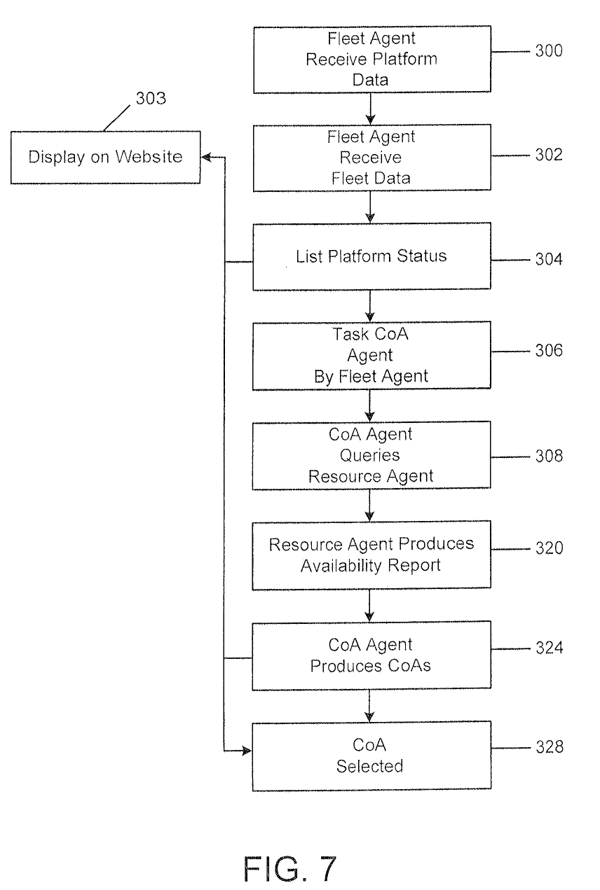

Turning now to FIG. 7 there is shown a flow chart for a process according to another embodiment of the disclosed cognitive decision support system 10 for fleet condition based management/maintenance support. In step 300, the fleet agent 100 may receive platform status information. In the broader fleet management context, this platform status information may include the geographic location of the platforms in the fleet, the current mission being performed, if any, the current condition, e.g., fueled and armed and on the flight deck, fueled and armed but on the hanger deck, fueled but not armed on the hanger deck, etc. or like status information in the non-military context, and in the maintenance management context such as a list of faults and a weighted list of probable root causes received from an IVHM system 20. In a receive fleet data information step 302, a fleet agent 100 may query a database or cognitive decision support system for fleet data to define the fleet, the fleet overall mission and fleet platform mission capabilities, absent platform equipment faults that exist and impact platform mission capability status. In a list platform status step 304, the fleet agent 100 may list the mission capability status for platforms in the fleet and may display such on a web-site in a display step 303, which could include the mission capability status for a list of platforms and accompanying mission designations, or in the maintenance context the weighted list of platform equipment fault root causes. The fleet agent 100 in step 306 may task a course of action agent 160 to develop a list of courses of action. In a resource availability inquiry step 308 the CoA agent 160 may task a resource agent 170 to provide a resource availability report.

The resource availability report may be produced by the maintenance agent 170 in a resource availability report production step 320. The resource availability report may include in the broader fleet management context such information as a list of platforms, a mission capability status for each platform, the availability of a platform for a platform mission, capabilities of a weapon system on a platform, the time to fuel/arm the platform, the time to man the platform, the experience and capability of the platform crew, the capability of a platform already in the air to reach a certain point by a certain time, and the capability of returning from that point to a carrier/airfield after performing a mission at the point, the existence of space on board and equipment to load/unload a package of a certain size and weight, the estimated time of pick-up at a point A and subsequent delivery at point b, etc. In the maintenance context, the resource availability report may include an assessment of the availability of maintenance resources such as the consumables, parts and materials needed to correct the particular platform equipment fault root cause and their availability along with the availability of a maintenance facility, trained and experienced maintenance personnel and any special metrology or diagnostic equipment to perform the correction of the particular root cause, and an assessment of likelihood of success in performing a platform mission.

In a course of action production step 324 the CoA agent 160, using, e.g., the IVHM system 20 report of the faults and weighted possible root causes, the fleet information regarding requirements for being at a particular level of mission capability and the resource availability report can generate a list of courses of action, which may be weighted. These may include in the broader fleet management context such items as divert aircraft A1 from location L1 and aircraft A2 from location L2 and launch aircraft A3 from the carrier for rendezvous at point P to attack the target, or launch squadron S to attack the target, of load package on truck T1 at location L1 to ship to location L2, or await the arrival of truck T2 at location L1 and load the package for delivery to location L2, and like courses of action. In the maintenance context these courses may be such as, for a given platform fault, repair part #1, defer to next scheduled maintenance, divert platform to repair facility X, repair part #2, etc. The courses of action may be weighted such as by likelihood of success, fastest possible response, only response available to imminent attack, least likely to cause damage or injury to friendly platforms/crews, or most likely to avoid lost opportunity costs, best financial choice, optimum choice given the platform status and fleet mission needs and likelihood of the fault in the particular platform impacting platform mission performance and/or overall fleet mission performance, etc.

The CoAs may be provided to a decision maker, e.g., by being listed on a web-page 140 in a display step 303. The display in display step 303 may include the weighted score for each listed course of action and/or some explanation of the reason the choice is ranked higher on the list than another choice. The decision maker may be a human being and may select a particular CoA, in a CoA selection step 328. The decision maker may inform the CoA agent 160 of the CoA that has been selected. The decision maker may make the selection by interfacing with the CoA agent through the web-page 140, of if the decision maker is some further automated decision maker based on rules/models and a knowledge base, then the web=page 140 may be unnecessary.

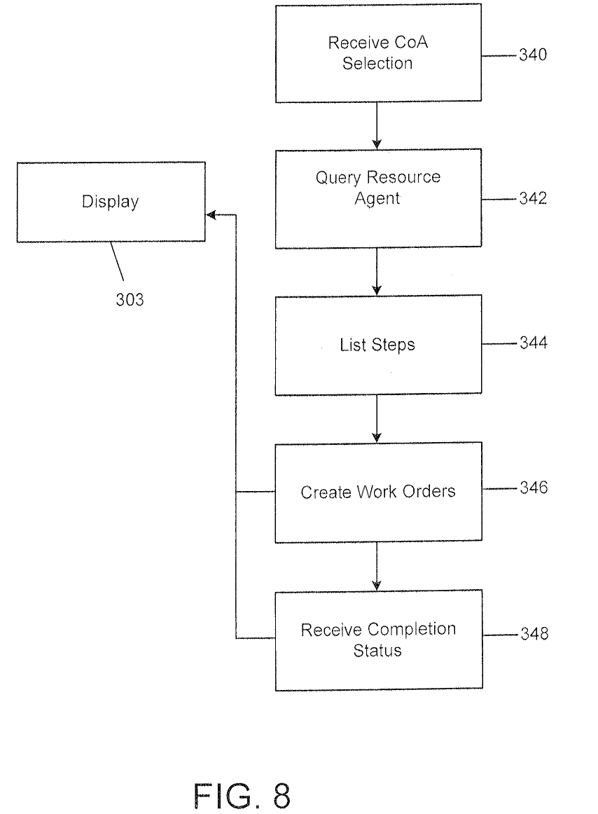

Turning now to FIG. 8 there is illustrated a flow diagram for a further process according to an embodiment of the disclosed subject matter. Once the course of action is selected, the CoA agent 160 receives the course of action in a course of action selection receipt step 340. The CoA agent 160, in a query resource agent step 342, may query a resource agent, such as the maintenance agent 170, to list the steps needed to carry out the course of action for which a work order may be produced. In a step 344 the queried agent may list the steps for which a work order is needed. The CoA agent may then task a work order producing system to produce the needed work orders in a step 346. The work orders may be displayed such as on a web-page 200 in a display step 303 and the Coa agent may receive feedback as to the completion status on each work order in a receive completion status step 348, with the completion status also displayed in a display step 303 on the web-page 200.

It should be emphasized that the above-described embodiments of the method and apparatus of the disclosed subject matter are merely possible examples of implementations, merely set forth for a clear understanding of the principles of the operation of the method and apparatus. Many variations and modifications may be made to the above-described embodiments without departing substantially from the spirit and principles of the operation of the disclosed subject matter. All such modifications and variations are intended to be included herein within the scope of this disclosure and the claimed subject matter should be so interpreted.

By way of example, the various agents should not be limited to the hardware and software, databases and the like described in the exemplary embodiments herein or to the possible location of and boundaries of such hardware, software and databases and the like. In fact, many may be located in the same facility and share common hardware, software, memory storage facilities and media and the like. Some may to some extent be distributed and separated in space and/or associated hardware and software from that disclosed. The cognitive decision making agents should be interpreted more by work flow, functionality and cooperation with the other agents. As an example, in many embodiments the functionalities of the IVHM system 20 and fleet agent 100 may be modified from embodiments specifically discussed herein and be segregated and/or overlapped in other ways. As noted above, and in other ways, the generation of condition based response activities and their ranking based on monitoring fleet platform conditions (faults and the like) may be entirely the function of the IVHM 20 or the fleet agent 100 or shared between the two, perhaps on a platform specific basis or platform location specific basis, such that the IVHM 20 and fleet agent 100 may be considered as one system for monitoring platform conditions throughout the fleet and providing the CoA agent 160 with the ordered listing of platform equipment condition based response activities, such as maintenance activities (identification of root causes needed to be addressed), and exactly which (IVHM 20, Fleet agent 100, or perhaps even additional systems) performs which function and whether that changes across the fleet, e.g., by platform, location or the like, or over time, is not of concern to the overall operation of the fleet management/maintenance system of the disclosed subject matter.

Similar modifications in the nature of cross-functionalities and/or separation of functionalities could take place between the fleet agent 100 and CoA agent 160 and the CoA agent 160 and resource assessment agent 170, etc. As another example, the work order generation disclosed to be done within the CoA agent 160 could be shared between the maintenance agent 170 and some entirely different agent functioning in the manner of the CoA agent as described above in regard to work order generation and completion monitoring.

The specific rules/models and knowledge base(s) employed in the various cognitive decision making support systems of the present application are not expressly disclosed, nor is specific software or code. It is believed that those skilled in the art would understand how to assemble and use such systems to implement the functionalities of the disclosed subject matter. In addition they may vary for a very wide variety of reasons which may be, e.g., related to the makeup of the fleet, its mission and individual platform missions, historical information about the management/maintenance of such a fleet to carry out the overall mission and the conduct of platform missions in support of the fleet mission, and available time, resources, personnel, funding, inventory, logistics and the like.

Thus, it should be apparent that the scope and content of the disclosed subject matter and the accompanying claims are not limited to the above embodiments but should be considered in scope and content taking into account the manner in which the disclosed embodiments may be changed and modified without departing from the scope and spirit of the disclosed subject matter and claims, some of which changes and modifications have been noted above.

We claim:

1. A fleet management system comprising:
a first cognitive decision support system configured to process information regarding a plurality of platforms comprising a fleet capable of an overall fleet mission, the first cognitive decision support system further configured to generate a list of condition based response activities for one or more platforms of the plurality of platforms and a weighted ranking of the probability of success of each such condition based response activity;
a second cognitive decision support system capable of being tasked by the first cognitive decision support system to, and configured to, provide a plurality of ranked courses of action for the one or more platforms; and
a third cognitive decision support system capable of being tasked by the second cognitive decision support system to, and configured to, assess the resource availability for each condition based response activity;
wherein the second cognitive decision support system is further configured to generate from the list of condition based response activities and the resource availability assessment for each condition based response, a plurality of recommended courses of action for the one or more platforms.

2. The fleet management system of claim 1, wherein:
the second cognitive decision support system is configured to rank the courses of action for the platform.

3. The fleet management system of claim 1, wherein:
the resource availability assessment comprises an availability of a platform for a platform mission and an assessment of likelihood of success in performing the platform mission.

4. The fleet management system of claim 1, wherein:
the resource availability assessment comprises an assessment of the availability of maintenance resources.

5. The fleet management system of claim 3, wherein:
the third cognitive decision support system is further configured to assess information regarding steps required to perform a condition based maintenance response and availability of any resource needed to perform each such condition based maintenance response.

6. A fleet mission performance management system comprising:
a fleet agent capable of receiving status information regarding platforms within a fleet of platforms, fleet data information defining the platforms comprising the fleet, and a mission capability of each platform for a particular platform mission and platform equipment requirements for such mission capability, the fleet agent being configured to generate a list of condition based response activities for each platform and a probability of success of each such condition based response activity;
a course of action agent configured to receive the list of the condition based response activities from the fleet agent and to utilize the list of condition based response activities to generate a resource availability request for each such condition based response activity; and
a resource agent configured to receive the resource availability request and access information regarding the performance steps needed to perform each such condition based response activity, and the availability of any resource needed to perform each such performance step, the resource agent further configured to generate a resource availability status report to the course of action agent;
wherein the course of action agent is further configured to use the resource availability status report for each condition based response activity, and provide a weighted list of courses of action.

7. The fleet management system of claim 6, wherein:
the course of action agent is further configured to produce the weighted list of courses of action using the list of condition based response activities, the resource availability report and a set of rules and a knowledge base.

8. The fleet management system of claim 6, wherein:
the resource availability status report comprises a list of platforms and a mission capability status for each platform.

9. The fleet management system of claim 6, wherein:
the resource availability request comprises a request for a maintenance resource availability status report.

10. The fleet management system of claim 6, wherein:
the fleet agent, the course of action agent and the resource agent each comprises a cognitive decision support system.

11. The fleet management system of claim 7, wherein:
the fleet agent, the course of action agent and the resource agent each comprises a cognitive decision support system.

12. The fleet management system of claim 8 wherein:
the fleet agent, the course of action agent and the resource agent each comprises a cognitive decision support system.

13. A fleet maintenance management system comprising:
a fleet agent capable of receiving status information regarding platforms within a fleet of platforms, fleet data information defining the platforms comprising the fleet, the status information comprising a list of condition based maintenance response activities and for each activity in the list of condition based maintenance response activities, a weighting of the likelihood that each activity will resolve a fault condition in a fleet platform;
a course of action agent configured to receive the list of the condition based maintenance response activities from the fleet agent and utilize the list of condition based maintenance response activities to generate a resource availability request for each such condition based maintenance response activity; and
a resource agent configured to receive the resource availability request and access information regarding the performance steps needed to perform each such condition based maintenance response activity, and the availability of any resource needed to perform each such performance step, the resource agent further configured to generate a condition based maintenance response resource availability status report to the course of action agent;
wherein the course of action agent is further configured to use the resource availability status report for each condition based maintenance response activity and provide a weighted list of courses of action.

14. The fleet maintenance management system of claim 13 wherein:
the course of action agent is further configured to produce the weighted list of courses of action utilizing the weighted list of condition based maintenance response activities, the resource availability report and a set of rules and a knowledge base.

15. The fleet maintenance management system of claim 13 wherein:
the fleet agent, the course of action agent and the resource agent each comprises a cognitive decision support system.

16. The fleet management system of claim 14 wherein:
the fleet agent, the course of action agent and the resource agent each comprises a cognitive decision support system.

17. A method for managing fleet mission performance, the method comprising:
receiving status information regarding platforms within a fleet of platforms and fleet data information defining mission capability of particular platforms for a particular platform mission in a fleet agent and generating in the fleet agent an output comprising a list of the status of platform mission capability for each platform for at least one mission;
receiving the list of the status of platform mission capability from the fleet agent in a course of action agent and utilizing the course of action agent to generate a list of condition based response activities and to generate a resource availability request for each such condition based response activity;
receiving the resource availability request in a resource agent and accessing through the resource agent, information regarding the performance steps needed to perform each such condition based response activity and the availability of any resource needed to perform each such performance step, and generating in the resource agent a resource availability status report to the course of action agent; and
using the resource availability status report for each condition based response activity in the course of action agent along with an operational requirements rules engine and associated knowledge base to generate a set of courses of action.

18. The method of claim 17 wherein:
the fleet agent, the course of action agent and the resource agent each comprises a cognitive decision support system.

19. The method of claim 17 further comprising:
ranking each action in the set of courses of action at the course of action agent.

20. The method of claim 17 wherein:
the resource availability status report comprises availability of a platform for a platform mission and an assessment of likelihood of success in performing the platform mission.
